(19) United States
(12) Patent Application Publication
(10) Pub. No.: US 2016/0267349 A1
(43) Pub. Date: Sep. 15, 2016

(54) METHODS AND SYSTEMS FOR GENERATING ENHANCED IMAGES USING MULTI-FRAME PROCESSING

(71) Applicant: MICROSOFT TECHNOLOGY LICENSING, LLC, Redmond, WA (US)

(72) Inventors: Mohammed SHOAIB, Redmond, WA (US); Jie LIU, Medina, WA (US); Richard Wales STOAKLEY, Seattle, WA (US); Matthieu Tony UYTTENDAELE, Seattle, WA (US)

(21) Appl. No.: 14/715,561

(22) Filed: May 18, 2015

Related U.S. Application Data
(60) Provisional application No. 62/131,815, filed on Mar. 11, 2015.

(51) Int. Cl. G06K 9/52; G06T 11/60; H04N 5/44; H04N 5/265; G06F 17/30; G06T 5/00; G06T 7/00

(52) U.S. Cl. CPC G06K 9/52; G06T 5/00; G06T 11/60; G06T 7/0024; H04N 5/265; G06F 17/3028; H04N 5/44

(57) ABSTRACT

Examples of the disclosure enable multi-frame processing of images to be efficiently performed. In some examples, one or more interest points are identified in a plurality of images. One or more features are extracted from the one or more interest points using an extraction algorithm. Based on the one or more extracted features, the plurality of images are registered to generate a plurality of registered images. The registered plurality of images are combined to generate a composite image. Aspects of the disclosure facilitate increasing speed, conserving memory, reducing processor load or an amount of energy consumed, and/or reducing network bandwidth usage.

### CROSS-REFERENCE TO RELATED APPLICATIONS

This application claims the benefit of U.S. Provisional Application No. 62/131,815, filed Mar. 11, 2015.

This application is related to Context-Awareness Through Biased On-Device Image Classifiers, filed concurrently herewith and incorporated by reference herein.

This application is related to Methods and Systems for Low-Energy Image Classification, filed concurrently herewith and incorporated by reference herein.

This application is related to Two-Stage Vector Reduction Using Two-Dimensional and One-Dimensional Systolic Arrays, filed concurrently herewith and incorporated by reference herein.

### BACKGROUND

Two or more images may be combined during multi-frame processing (MFP) to create an enhanced image. MFP enables various applications, such as high-dynamic range imaging (HDR), de-noising, image stabilizing, de-blurring, super-resolution imaging, de-hazing, and panoramic stitching.

One existing method of MFP includes taking a first photograph at a first time, taking a second photograph at a second time, and merging the first photograph with the second photograph to create a fused image. This method is relatively time consuming, taking approximately two seconds per fused image on a conventional mobile device. Moreover, the fused image may include one or more artifacts when a camera taking the photographs or one or more objects in the photographs move between the first time and the second time.

One known method of reducing a quantity of artifacts uses a super HDR (S-HDR) image sensor that interleaves a taking of a first photograph by a first sensor and a taking of a second photograph by a second sensor. However, the super HDR image sensor requires additional hardware that is typically application-specific and, thus, not generalizable. Another known method of reducing a quantity of artifacts uses a post-processing algorithmic solution using two computational steps: image alignment and image fusing. However, processing these two computational steps is generally slow (e.g., more than 1.8 seconds per frame and about one second total, respectively) and/or consumes substantial power.

### SUMMARY

Examples of the disclosure process a plurality of images (e.g., multi-frames) to generate an enhanced image. In some examples, images are processed using a specialized accelerator and algorithm that registers the images to a common coordinate system. In one example, a system includes a sensor module that generates a plurality of images and transmits the plurality of images to a first frame bus. An image sensor processor module retrieves the plurality of images from the first frame bus, processes the plurality of images, and transmits the plurality of processed images to the first frame bus. An accelerator module retrieves the plurality of processed images from the first frame bus, registers each image of the plurality of processed images, and transmits the plurality of registered images to a second frame bus. A processor module retrieves the plurality of registered images from the second frame bus and combines the plurality of registered images to generate a composite image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a computing device that may be used for multi-frame processing;

FIG. 2 is a block diagram of an example hardware architecture for performing multi-frame processing on a computing device, such as the computing device shown in FIG. 1;

FIG. 3 is a flowchart of an example method for processing images on a hardware architecture, such as the hardware architecture shown in FIG. 2;

FIG. 4 is a block diagram of an example interest point-detection module that may be used with a hardware architecture, such as the hardware architecture shown in FIG. 2;

FIG. 5 is a flowchart of an example method for detecting one or more interest points using an interest point-detection module, such as the interest point-detection module shown in FIG. 4;

FIG. 6 is a block diagram of an example feature-extraction module that may be used with a hardware architecture, such as the hardware architecture shown in FIG. 2;

FIG. 7 illustrates example pooling patterns that may be used with a feature-extraction module, such as feature-extraction module shown in FIG. 6;

FIG. 8 illustrates an example two-level vector reduction that may be implemented using a hardware architecture, such as the hardware architecture shown in FIG. 2;

FIG. 9 is a block diagram of an example systolic array that may be used to implement a two-level vector reduction, such as the two-level vector reduction shown in FIG. 8;

FIG. 10 illustrates an example stage of a two-level vector reduction, such as the two-level vector reduction shown in FIG. 8;

Corresponding reference characters indicate corresponding parts throughout the drawings.

### DETAILED DESCRIPTION

The disclosed system includes an architecture configured to perform multi-frame processing. Images are combined to generate an enhanced image to enable various applications including high-dynamic range imaging (HDR), super high-dynamic range imaging (S-HDR), de-noising, image stabilizing, de-blurring, super-resolution imaging, de-hazing, panoramic stitching, depth of field stacking, and rolling shutter correcting. The architecture includes one or more processors that process images and/or frames as they stream in and transmit the images to a hardware-specialized accelerator (e.g., a dedicated geometric image transformation engine) that registers one or more images in an energy- and/or time-efficient manner. The registered images are then combined or composited by one or more processors and streamed out for use and/or presentation.

The present disclosure describes utilizing a feature-based approach to take advantage of properties of invariance, uniqueness, stability, and independence. These characteristics enable a more robust and accurate frame alignment to be achieved. The disclosed system utilizes a plurality of algorithms and their associated hardware architecture. For example, the algorithms may include interest-point detection, feature extraction, feature matching, transform model, homography estimation, image resampling, image transformation, and/or image warping. In one example, the accelerator is realized in a system on a chip through low-level blocks, which allow stream processing through several architectural concepts such as two-stage vector reducing, hierarchical pipelining, and/or substantial local buffering.

Local buffering is utilized at various stages of processing to leverage the architectural elements described herein. In some examples, buffering data locally decreases or eliminates the need to re-fetch data from external memory, lowering memory bandwidth and/or local storage used. Additionally or alternatively, fine-grained parallel implementations are used within various processing elements of the accelerator. For example, many blocks involve a series of two-level vector reduction operations. The disclosed system employs arrays of specialized processing elements that are interconnected to exploit this computation pattern.

In at least some examples, the system is configured based on power and/or performance requirements of a given application. For example, a portable device in a vehicle may have greater access to battery and computing resources with fewer size constraints than a smartphone. The configuration may be altered to optimize speed of performance without consideration for energy usage. Thus, the accelerator may be scaled to cater to the performance constraints of the system described herein and/or the energy constraints of the device.

Aspects of the disclosure facilitate increasing speed, conserving memory, reducing processor load or an amount of energy consumed, and/or reducing network bandwidth usage by registering a plurality of images to a common coordinate system and/or by calculating one or more values, storing the one or more values in a local buffer, and reusing the one or more values. Local buffering is utilized at various stages of processing to leverage the architectural elements described herein. In some examples, buffering data locally decreases or eliminates the need to re-fetch data from external memory, lowering memory bandwidth and/or local storage used. Additionally or alternatively, fine-grained parallel implementations are used within various processing elements of the accelerator. For example, many blocks involve a series of two-level vector reduction operations. The disclosed system employs arrays of specialized processing elements that are interconnected to exploit this computation pattern. The disclosed architecture is pipelined, with several modules running in parallel, to facilitate processing images more quickly and efficiently.

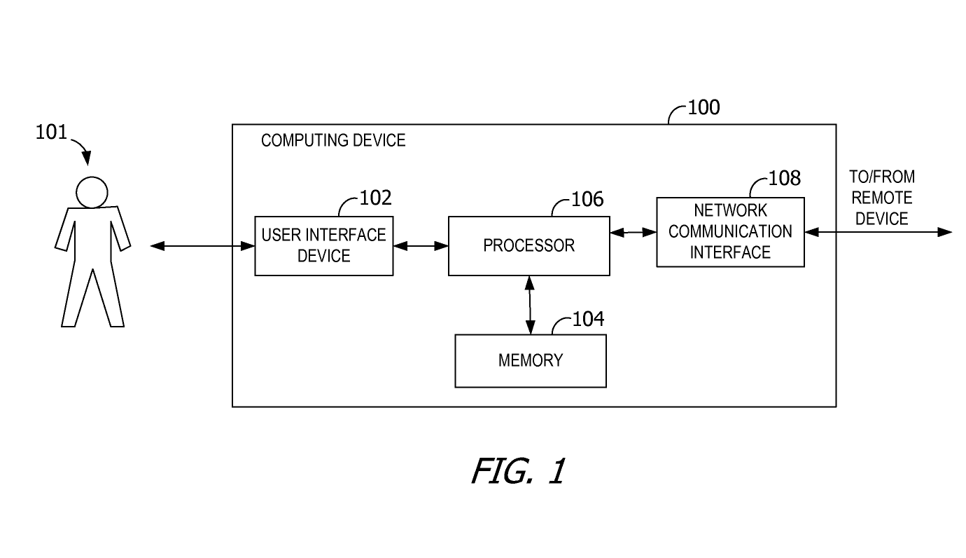

FIG. 1 is a block diagram of a computing device 100 that may be used with the systems described herein. The computing device 100 may be a mobile device. While some examples of the disclosure are illustrated and described herein with reference to the computing device 100 being a mobile device, aspects of the disclosure are operable with any device that generates, captures, records, retrieves, or receives images (e.g., computers with cameras, mobile devices, security systems). For example, the computing device 100 may include a portable media player, mobile telephone, tablet, netbook, laptop, desktop personal computer, computing pad, kiosks, tabletop devices, industrial control devices, wireless charging stations, electric automobile charging stations, and other computing devices. Additionally, the computing device 100 may represent a group of processing units or other computing devices.

A user 101 may operate the computing device 100. In some examples, the computing device 100 may be always on, or the computing device 100 may turn on and/or off in response to stimuli such as a change in light conditions, movement in the visual field, change in weather conditions, etc. In other examples, the computing device 100 may turn on and/or off in accordance with a policy. For example, the computing device 100 may be on during predetermined hours of the day, when a vehicle is on, etc.

The computing device 100, in some examples, includes a user interface device or interface module 102 for exchanging data between the computing device 100 and the user 101, computer-readable media, and/or another computing device (not shown). In at least some examples, the interface module 102 is coupled to or includes a presentation device configured to present information, such as text, images, audio, video, graphics, alerts, and the like, to the user 101. For example, the presentation device may include, without limitation, a display, speaker, and/or vibrating component. Additionally or alternatively, the interface module 102 is coupled to or includes an input device configured to receive information, such as user commands, from the user 101. For example, the input device may include, without limitation, a game controller, camera, microphone, and/or accelerometer. In at least some examples, the presentation device and the input device may be integrated in a common user-interface device configured to present information to the user 101 and receive information from the user 101. For example, the user-interface device may include, without limitation, a capacitive touch screen display and/or a controller including a vibrating component.

The computing device 100 includes one or more computer-readable media, such as a memory area 104 storing computer-executable instructions, video or image data, and/or other data, and one or more processors 106 programmed to execute the computer-executable instructions for implementing aspects of the disclosure. The memory area 104 includes any quantity of media associated with or accessible by the computing device 100. The memory area 104 may be internal to the computing device 100 (as shown in FIG. 1), external to the computing device 100 (not shown), or both (not shown).

In some examples, the memory area 104 stores, among other data, one or more applications. The applications, when executed by the processor 106, operate to perform functionality on the computing device 100. Example applications include mail application programs, web browsers, calendar application programs, address book application programs, messaging programs, media applications, location-based services, search programs, and the like. The applications may communicate with counterpart applications or services such as web services accessible via a network (not shown). For example, the applications may represent downloaded client-side applications that correspond to server-side services executing in a cloud.

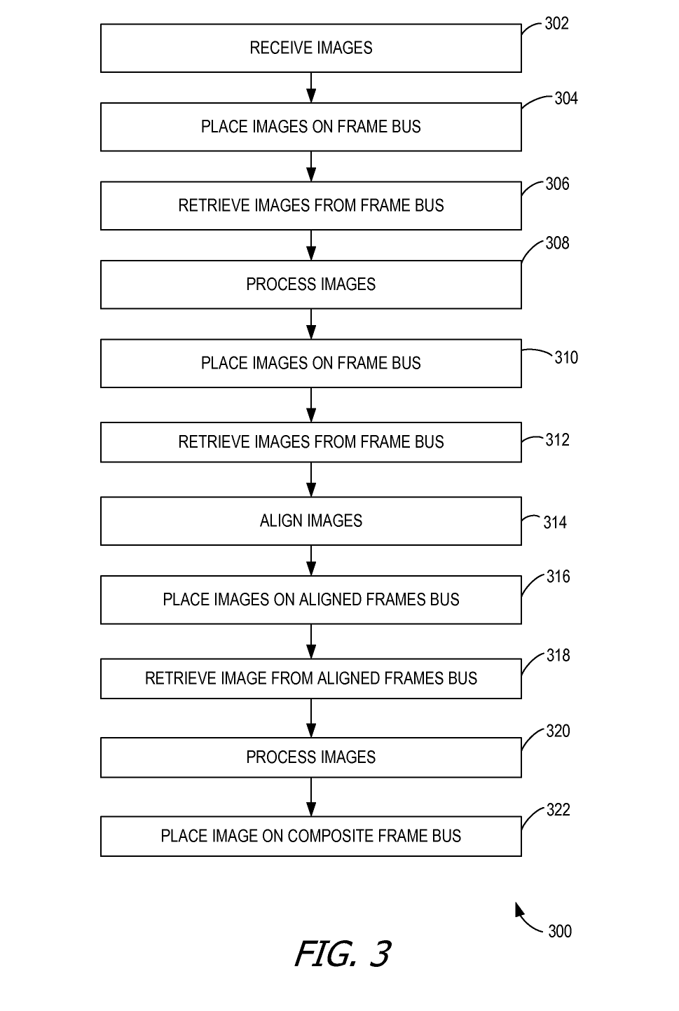

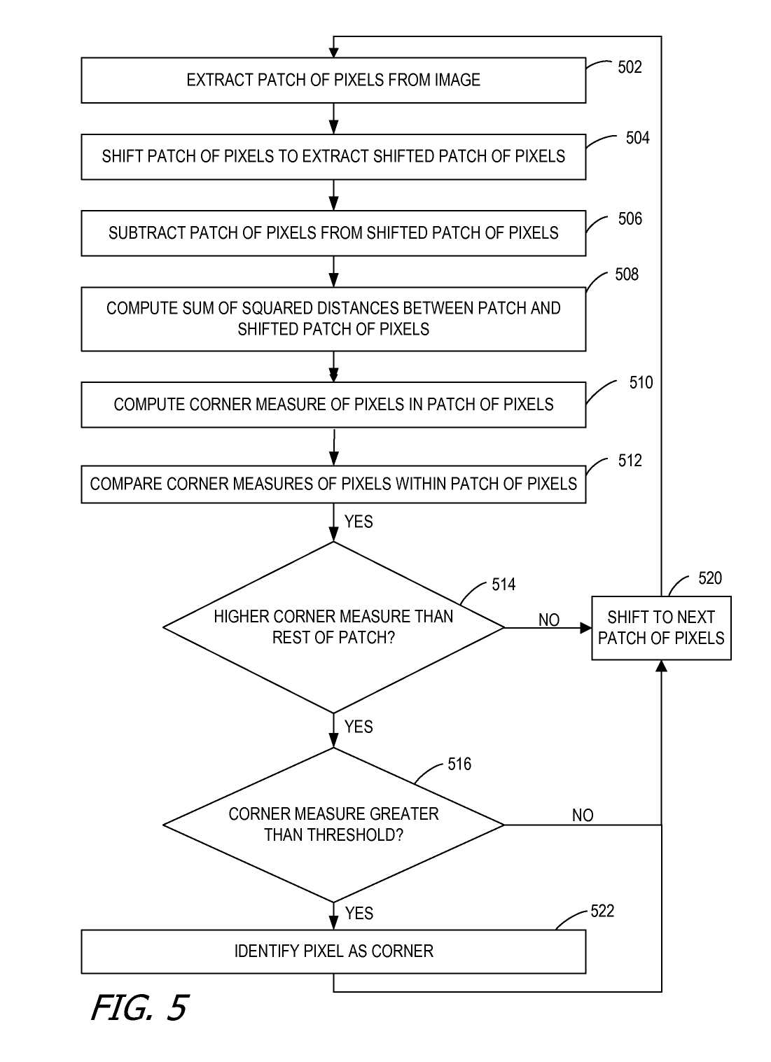

The processor 106 includes any quantity of processing units, and the instructions may be performed by the processor 106 or by multiple processors within the computing device 100 or performed by a processor external to the computing device 100. The processor 106 is programmed to execute instructions such as those illustrated in the figures (e.g., FIGS. 3 and 5).

The processor 106 is transformed into a special purpose microprocessor by executing computer-executable instructions or by otherwise being programmed. For example, the processor 106 may execute the computer-executable instructions to identify one or more interest points in a plurality of images, extract one or more features from the one or more interest points, register the plurality of images, and/or combining the plurality of images. Although the processor 106 is shown separate from the memory area 104, examples of the disclosure contemplate that the memory area 104 may be onboard the processor 106 such as in some embedded systems.

In this example, the memory area 104 stores one or more computer-executable components for multi-frame processing of images. A network communication interface 108, in some examples, exchanges data between the computing device 100 and a computer-readable media or another computing device (not shown). In at least some examples, the network communication interface 108 transmits the image to a remote device and/or receives requests from the remote device. Communication between the computing device 100 and a computer-readable media or another computing device may occur using any protocol or mechanism over any wired or wireless connection.

The block diagram of FIG. 1 is merely illustrative of an example system that may be used in connection with one or more examples of the disclosure and is not intended to be limiting in any way. Further, peripherals or components of the computing device 100 known in the art are not shown, but are operable with aspects of the disclosure. At least a portion of the functionality of the various elements in FIG. 1 may be performed by other elements in FIG. 1, or an entity (e.g., processor, web service, server, application program, computing device, etc.) not shown in FIG. 1.

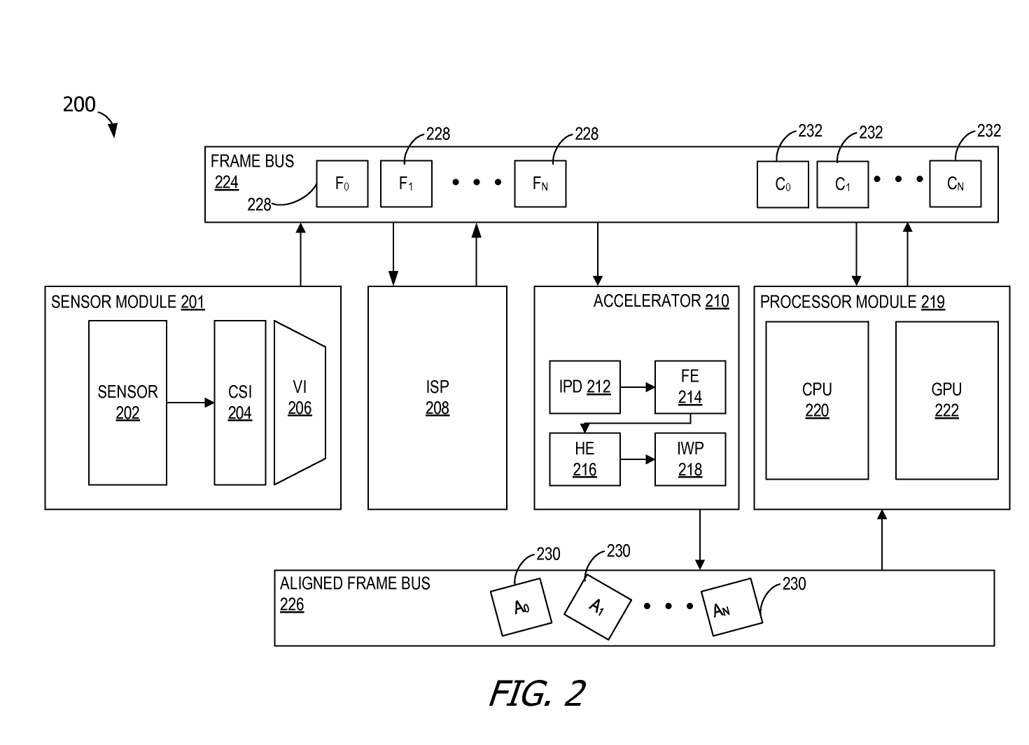

FIG. 2 illustrates a functional block diagram of a hardware architecture on a computing device 200 (e.g., computing device 100) for multi-frame processing. A sensor module 201 includes a sensor 202 and a camera serial interface (CSI) 204 and/or a video interface (VI) 206 coupled to the sensor 202. In some examples, the sensor 202 is configured to capture one or more raw images 228 or frames of video, which are transmitted through the CSI 204 and/or VI 206 and transmitted to or placed onto a first frame bus (e.g., frame bus) 224. Additionally or alternatively, raw images 228 are captured elsewhere and placed onto the first frame bus 224.

An image signal processor (ISP) 208 is configured to retrieve or pull down one or more raw images 228 from the first frame bus 224 and clean up or otherwise process the raw images 228. The ISP 208 may place one or more processed images onto the first frame bus 224 (raw images 228 and processed images are represented as F₀, F₁ . . . F_{N} in FIG. 2)

An accelerator 210 is configured to retrieve and/or pull down one or more images 228 from the first frame bus 224 and align or register the images 228. The accelerator 210 may place one or more registered images 230 onto a second frame bus (e.g., aligned frame bus) 226. In some examples, the accelerator 210 includes an interest point-detection (IPD) module 212, a feature-extraction (FE) module 214, a homography estimation (HE) module 216, and/or an image warping (IWP) or warp module 218. Alternatively, the accelerator 210 may include any combination of modules that enables the computing device 200 to function as described herein.

The IPD module 212 may retrieve or take one or more images 228 from the first frame bus 224 and detect, identify, or search for one or more relevant interest points on the images 228. Interest-point detection helps identify pixel locations associated with relevant information. Examples of pixel locations include closed-boundary regions, edges, contours, line intersections, corners, etc. In one example, corners are used as interest points because corners form relatively robust control points and/or detecting corners has a relatively low computational complexity. The FE module 214 may extract one or more features from the interest points using, for example, a daisy feature-extraction algorithm. The HE module 216 may align, shift, or register one or more images 228 such that the images utilize the same or a common coordinate system. The IWP module 218 warps, modifies, or adjusts one or more images 228 such that the images 228 are aligned. One or more registered images 230 are placed on the aligned frame bus 226.

A processor module 219 includes a central processing unit (CPU) 220 and/or a graphics processing unit (GPU) 222 configured to retrieve or pull down one or more registered images 230 from the aligned frame bus 226 and combine or composite the images and place the composite images 232 onto the first frame bus 224. In at least some examples, the CPU 220 and/or GPU 222 are interchangeable.

Images 228 are consumed by the accelerator 210 and are replaced on the first frame bus 224 by the processor module 219 with composite images 232. In at least some examples, raw images 228 are consumed by the ISP 208 and are replaced on the first frame bus 224 by the ISP 208 with processed images. This consumption and/or replacement process enables the first frame bus 224 to run at or below capacity. In some examples, the computing device 200 includes a third bus (not shown) onto which the processor module 219 places the composite images 232. In some examples, one or more frame buses 224 and 226 are alternating, non-colliding, or isolated. This reduces an opportunity for an element of the architecture from being starved and/or from acting as a bottleneck to another element of the architecture. In this example, one or more frame buses 224 and 226 are connected to an application or another output, for instance, on a mobile device (not illustrated). In some examples, the frame buses 224 and 226 are connected to an output using a multiplexer (not illustrated).

FIG. 3 is a flowchart of a method 300 for processing images using the computing system. Images 228, such as raw images or video frames, are received (e.g., from the sensor 202) at 302 and placed on a frame bus 224 at 304. In at least some examples, one or more images are received or retrieved from one or more sources (e.g., two adjacent sensors, two remote sensors, a single sensor with per pixel exposure settings or per pixel focus). In at least some examples, an ISP 208 retrieves the images 228 at 306, processes the images 228 at 308, and places the processed images on the frame bus 224 at 310. The accelerator 210 retrieves the raw images 228 and/or processed images from the frame bus 224 at 312 and registers the images at 314. The accelerator 210 may identify one or more interest points in the images 228, extract one or more features from the interest points, and/or register the images 228 to generate registered images 230. The registered images 230 are placed on an aligned frame bus 226 at 316. The processor module 219 retrieves the registered images 230 from the second frame bus 226 at 318 and combines or composites the registered images 230 at 320. The composite images 232 are placed on a composite frame bus at 322, where they may be retrieved by an application or display. In at least some examples, the composite images are placed on the frame bus 224, which may have at least some capacity. In other examples, the composite frame bus is a third frame bus (not shown).

Some examples of the disclosure are illustrated and described herein with reference to modules of the computing device residing or being positioned at a mobile device. Additionally or alternatively, at least some modules (e.g., the acceleration module or at least some submodules included in the acceleration module) may reside or be positioned at a remote computing device or server coupled to a plurality of mobile devices or image sources (e.g., sensor 202). At least some modules may be configured to receive or retrieve one or more images from a network location and transmit one or more images to the network location or another network location. For example, the computing system may implement daughter-card based acceleration in the cloud. In this manner, the computing system may be configured to generate an enhanced image based on any number of images taken at any time from any number of image sources.

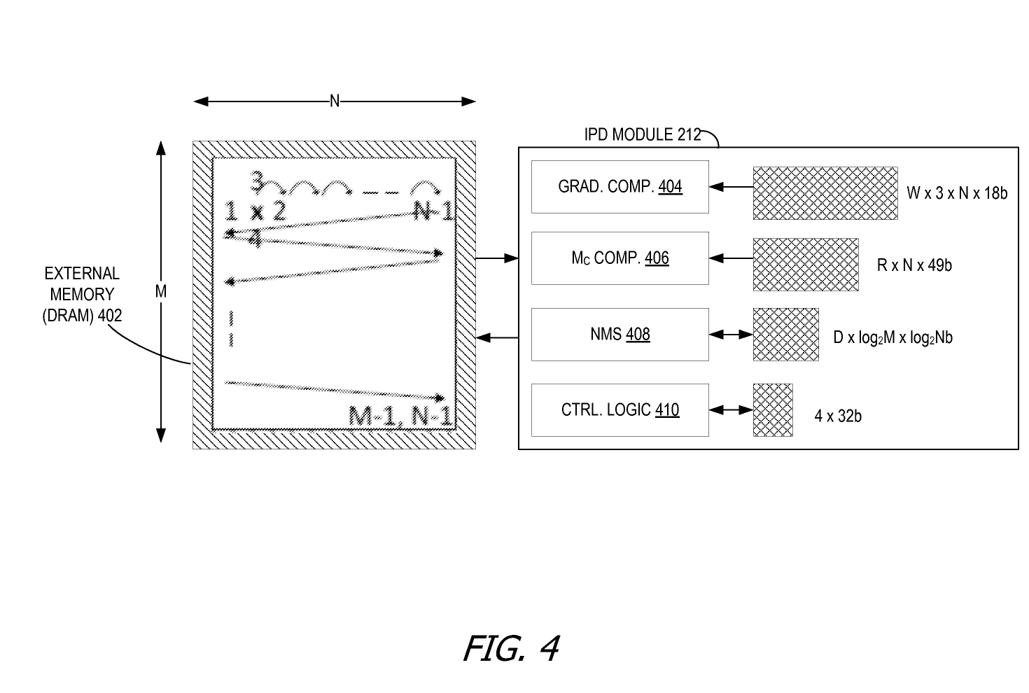

FIG. 4 shows a block diagram of an IPD module 212 configured to implement an IPD algorithm such that one or more pixels including or associated with relevant information (e.g., interest point) may be identified. An interest point may be, for example, a corner, arch, edge, blob, ridge, texture, color, differential, lighting change, etc. in the image. For example, the system described herein utilizes the Harris-Stephens algorithm, which detects pixels associated with object corners. Additionally or alternatively, any algorithm that any interest point may be used. In some examples, a policy that allows the interest-point detection to change based on preceding image detection is utilized. For instance, if a pattern of images is identified, an algorithm associated with or particular to the images in the identified pattern may be selected.

An interest point includes or is associated with, in some examples, multiple pixels. In other examples, the interest point includes or is associated with only a single pixel. A predetermined number (e.g., four) of neighboring or abutting pixels may be retrieved or fetched with each pixel associated with an interest point. In some examples, the pixels (e.g., 8b/pixel) are retrieved from external memory 402 using an address value that is generated by the IPD module 212. Thus, an external memory bandwidth for this operation is 4MN×8b/frame, where M and N are the height and width, respectively, of the grayscale frame. For video graphics array (VGA) resolution at 30 fps, the bandwidth is 281 Mbps and, for 720p high definition (HD) resolution at 60 fps, the bandwidth is 1.6 Gbps. These figures are relatively modest since typical double data rate type three synchronous dynamic random-access memories (DDR3 DRAMs) provide a peak bandwidth of up to several 10s of Gbps.

In some examples, the abutting pixels are used to compute gradients along the horizontal and/or vertical directions at 404, which are buffered into a local first-in, first-out (FIFO) memory of size W×3×N×18b (in a nominal implementation W=3 and the memory is of size 12.7 kB for VGA and 25.3 kB for 720p HD). These gradients are used to evaluate a corner measure (Me) at 406. The data path includes one CORDIC-based (COordinate Rotation DIgital Computer) divider. The resulting corner measures are put in a local FIFO of depth R (e.g., 3). This FIFO is thus of size 9.8 kB for VGA and 19.5 kB for 720p HD. The Mc values are processed by a non-maximum suppression (NMS) block at 408, which pushes the identified interest point locations (x and/or y coordinates) onto another local FIFO of depth D (e.g., 512) at 410. Thus, the FIFO capacity may be equal to 5.2 kB for VGA and 6.1 kB for 720p HD. When all pixels are accessed from external memory, the IPD module 212 consumes approximately 70.31 Mbps for VGA, 0.46 Gbps for 1080p, and approximately 1.85 Gbps for 4k image resolutions at 30 fps.

FIG. 5 is a flow chart illustrating operations of the IPD module 212 during interest-point detection. At 502, a patch of pixels I(x, y) is extracted around each pixel location (x, y) in a grayscale frame I. A shifted patch of pixels I(x+u, y+v) centered at location (x+u, y+v) is extracted at 504. The original extracted patch of pixels is subtracted from the shifted patch at 506. At 508, the result is used to compute the sum-of-squared distances [denoted by S(x, y)] using Equation 1 shown below:

S(x,y)=ΣᵤΣᵥw(u,v)[I(u+x,v+y)−I(u,v)]² (1)

where w(u, v) is a window function (matrix) that contains the set of weights for each pixel in the frame patch. The weight matrix may include a circular window of Gaussian (isotropic response) or uniform values. For example, the system described herein utilizes uniform values to simplify implementation. A corner is then characterized by a large variation of S(x, y) in all directions around the pixel at (x, y). In order to aid the computation of S(x, y), the algorithm exploits a Taylor series expansion of I(u+x, v+y) as shown in Equation 2 below:

I(u+x,v+y)≈I(u,v)+Iₓ(u,v)x+I_{y}(u,v)y (2)

where Iₓ(u, v)x and I_{y}(u, v)y are the partial derivatives of the image patch I at (u, v) along the x and y directions, respectively. Based on this approximation, S(x, y) may be expressed as shown in Equations 3a and 3b below:

S(x,y)≈ΣᵤΣᵥw(u,v)·[Iₓ(u,v)·x−I_{y}(u,v)·y]² (3a)

S(x,y)≈[x,y]A[x,y]^{T} (3b)

where A is a structure tensor that is given by Equation 4 shown below:

$$\vert \begin{matrix}< {I}_{x}^{2} > & < {I}_{x} {I}_{y} > \\ < {I}_{x} {I}_{y} > & < {I}_{y}^{2} >\end{matrix} \vert \qquad ( 4 )$$

To conclude that (x, y) is a corner location, the eigenvalues of A are computed. However, since computing the eigenvalues of A is computationally expensive, in at least some examples, at 510 the following corner measure M_{c′}(x, y) is computed, that approximates the characterization function based on the eigenvalues of A as shown in Equation 5 below:

M_{c′}(x,y)=det(A)−κ·trace²(A) (5)

To increase efficiency, the disclosure does not set the parameter κ, and instead uses a modified corner measure M_{c}(x, y), which amounts to evaluating the harmonic mean of the eigenvalues as shown in Equation 6 below:

M_{c}(x,y)=2·det(A)/[trace(A)+ε] (6)

where ε is a small arbitrary positive constant (that is used to avoid division by zero). After computing a corner measure [M_{c}(x, y)] at each pixel location (x, y) in the frame, the corner measure of each pixel is compared to the abutting pixels in the patch at 512. When a pixel has a higher corner measure than a corner measure of the rest of the abutting pixels at 514 or, in some examples, the remainder of the patch of pixels, then the corner measure is compared to a pre-specified threshold at 516. When it satisfies both criteria, it is marked as a corner at 522.

This process is called non-maximum suppression (NMS). The corners thus detected are invariant to lighting, translation, and rotation. If none of the examined pixels in the patch of pixels are identified as corners, then the next set of pixels is extracted at 520, and the process begins again at 502. In some examples, this process occurs iteratively until the entire image is examined. In other examples, when an image is identified and classified before the entire image is examined, the process is terminated.

### Feature Extraction

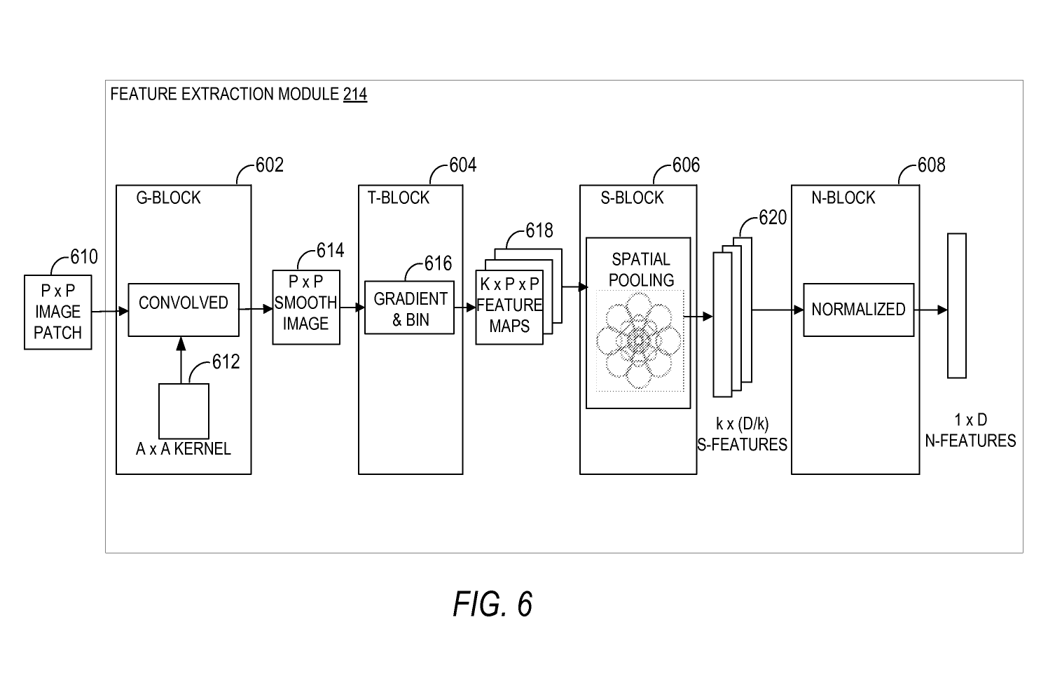

FIG. 6 shows a block diagram of a feature-extraction (FE) module 214 configured to implement the feature-extraction algorithm, such that one or more low-level features may be extracted from pixels around the interest points (e.g., the corners identified in the interest point-detection operation).

Typical classification algorithms use histogram-based feature-extraction methods, such as scale-invariant feature transform (SIFT), histogram oriented gradient (HoG), gradient location and orientation histogram (GLOH), etc. The FE module 214 enables a computation engine using a modular framework to represent or mimic many other feature-extraction methods depending on tunable algorithmic parameters that may be set at run-time. As shown in FIG. 6, the feature-extraction module includes a G-Block 602, a T-Block 604, an S-Block 606, an N-Block 608, and in some examples an E-Block (not illustrated).

In some examples, different candidate blocks are swapped in and out to produce new overall descriptors. In addition, parameters that are internal to the candidate features may be tuned in order to increase the performance of the descriptor as a whole. In this example, the FE module 214 is pipelined to perform stream processing of pixels. The feature-extraction algorithm includes a plurality of processing steps that are heavily interleaved at the pixel, patch, and frame levels.

In a first block or filter module, the FE module 214 includes a pre-smoothing or G-Block 602 that is configured to smooth a P×P image patch of pixels 610 around each interest point by convolving it with a two-dimensional Gaussian filter of standard deviation (σₛ). In one example, it is convolved with a kernel having dimensions A×A 612. This results in a smoothened P×P image patch of pixels 614. The number of rows and/or columns in the G-Block 602 may be adjusted to achieve a desired energy and throughput scalability.

In a second block or gradient module, the FE module 214 includes a transformation or T-Block 604 that is configured to map the P×P smoothened patch of pixels 614 onto a length k vector with non-negative elements to create k×P×P feature maps 618. At a high level, the T-Block 604 is a single processing element that generates the T-Block features sequentially. There are four sub-blocks defined for the transformation, namely, T1, T2, T3, and T4 (collectively illustrated as “Gradient and Bin” 616).

In sub-block T1, at each pixel location (x, y), the disclosure computes gradients along both horizontal (Δx) and vertical (Δy) directions. The magnitude of the gradient vector is then apportioned into k bins (where k equals 4 in T1a and 8 in T1b mode), split equally along the radial direction—resulting in an output array of k feature maps, each of size P×P.

In sub-block T2, the gradient vector is quantized in a sine-weighted fashion into 4 (T2a) or 8 (T2b) bins. For T2a, the quantization is done as follows: |Δₓ|−Δₓ; |Δₓ|+Δₓ; |Δ_{y}|−Δ_{y}; |Δ_{y}|+Δ_{y}. For T2b, the quantization is done by concatenating an additional length 4 vector using Δ₄₅ D45, which is the gradient vector rotated through 45 degrees.

In sub-block T3, at each pixel location (x, y), steerable filters are applied using n orientations, and the response is computed from quadrature pairs. Next, the result is quantized in a manner similar to T2a to produce a vector of length k=4n (T3a), and in a manner similar to T2b to produce a vector of length k=8n (T3b). In some examples, filters of second or higher-order derivatives and/or broader scales and orientations are used in combination with the different quantization functions.

In sub-block T4, two isotropic difference of Gaussian (DoG) responses are computed with different centers and scales (effectively reusing the G-block 602). These two responses are used to generate a length k=4 vector by rectifying the positive and negative parts into separate bins as described in T2.

In one example, only the T1 and T2 blocks are utilized. For example, the data path for the T-block 604 includes gradient-computation and quantization engines for the T1 (a), T1 (b), T2 (a), and T2 (b) modes of operation. In another example, T3 and T4 are also utilized. In some examples, various combinations of T1, T2, T3, and T4 are used to achieve different results. The T-block 604 outputs are buffered in a local memory of size 3×(R+2)×24b and the pooling region boundaries are stored in a local static random-access memory (SRAM) of size Np×3×8b.

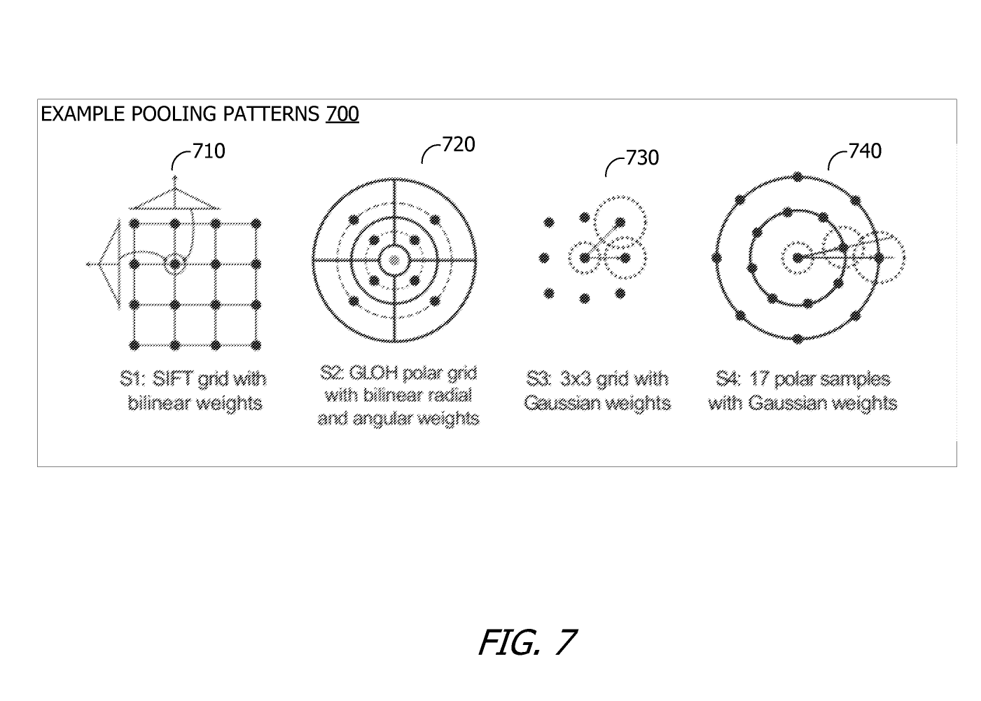

In a third block or pooler module, the FE module 214 includes a spatial pooling or S-Block 606 configured to accumulate the weighted vectors, the k×P×P feature maps 618, from the T-Block 604 to give N linearly summed vectors of length k 620. These N vectors are concatenated to produce a descriptor of length kN. In the S-Block 606, there are a configurable number of parallel lanes for the spatial-pooling process. These lanes include comparators that read out Nₚ pooling region boundaries from a local memory and compare with the current pixel locations. The power consumption and performance of the S-Block 606 may be adjusted by varying a number of lanes in S-Block 606. FIG. 7 illustrates various pooling patterns which are utilized in the S-Block 606 depending on the desired result.

In the final block or normalizer module, the FE module 214 includes a post normalization or N-Block 608 that is configured to remove descriptor dependency on image contrast. The output from the S-block 606 is processed by the N-block 608, which includes an efficient square-rooting algorithm and division module (based on CORDIC). In a non-iterative process, the S-Block 606 features are normalized to a unit vector (e.g., dividing by the Euclidean norm) and all elements above a threshold are clipped. The threshold is defined, in some examples, depending on the type of ambient-aware application operating on the mobile device or, in other examples, the threshold is defined by policies set by a user (e.g., user 101), the cloud, and/or an administrator. In some examples, a system with higher bandwidth, or more cost effective transmission, may set the threshold lower than other systems. In an iterative process, these steps repeat until a predetermined number of iterations has been reached.

Data precisions are tuned to increase an output signal-to-noise-ratio (SNR) for most images. The levels of parallelism in the system, the output precisions, memory sizes etc. may all be parameterized. Assuming no local data buffering between the IPD module 212 and FE modules 214, the feature-extraction block (for nominal ranges) consumes (assuming 64×64 patch size and 100 interest points) approximately 1.2 kB (4×4 two-dimensional array and 25 pooling regions) for a frame resolution of VGA (128×128 patch size and 100 interest points) and approximately 3.5 kB (8×8 two-dimensional array and 25 pooling regions) for a frame resolution of 720p HD. Local buffering between the IPD module 212 and FE module 214 enable those elements to work in a pipelined manner and, thus, mask the external data access bandwidth. Estimated storage capacities for the IPD module 212 and FE modules 214 are approximately 207.38 kB for VGA, 257.32 kB for 1080p, and approximately 331.11 kB for 4k image resolutions.

FIG. 7 illustrates various pooling patterns 700 that are utilized based on a desired result. In one example, a square grid 710 of pooling centers may be used. The overall footprint of this grid is a parameter. The T-block features are spatially pooled by linearly weighting them according to their distances from the pooling centers.

In another example, a spatial summation pattern 720, similar to the spatial histogram used in GLOH, may be used. The summing regions are arranged in a polar arrangement. The radii of the centers, their locations, the number of rings, and the number of locations per angular segment are all parameters that may be adjusted (0, 4, or 8) to facilitate increasing performance.

In yet another example, normalized Gaussian weighting functions are utilized to sum input regions over local pooling centers in a quadrilateral arrangement 730 (e.g., a 3×3 grid, a 4×4 grid, or a 5×5 grid). The sizes and the positions of these grid samples are tunable parameters.

In yet another example, a polar arrangement 740 of the Gaussian pooling centers is used instead of the rectangular arrangement 730. In at least some examples, the patterns for spatial pooling are stored in an on-chip memory along the borders of a two-dimensional-array (described below), and the spatially-pooled S-Block features are produced at the output. The number of lanes in the S-Block 606 may be adjusted to achieve a desired energy and throughput scalability.

In at least some examples, the FE module 214 includes an embedding or E-block (not shown) configured to reduce the feature vector dimensionality. The E-Block may include one or more sub-stages: principal component analysis (E1), locality preserving projections (E2), locally discriminative embedding (E3), etc. In one example of the present disclosure, the E-block is utilized to provide an option for extensibility.

### Feature Matching and Homography Estimation

This element of the disclosure estimates a homography automatically using a random sampling consensus (RANSAC) algorithm. Homography is a projection mapping between any two projection planes [points in the two planes are denoted by the co-ordinates (x, y) and (x′, y′)] with the same center of projection. In some examples, homography is utilized to align or register multiple images by shifting the images such that the images utilize the same or a common coordinate system. It is represented by a 3×3 matrix in homogeneous coordinates as shown in Equation 7 below:

$$( \begin{matrix}{wx}^{′} \\ {wy}^{′} \\ w\end{matrix} ) = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) ( \begin{matrix}x \\ y \\ 1\end{matrix} ) \qquad ( 7 )$$

The solution for a homography (e.g., finding the unknown hᵢⱼ's, and w in the above equation) are simplified through a least-square approximation. The solution entails finding the eigenvectors of an auxiliary matrix ATA with the smallest eigenvalue. The matrix A comprises combinations of the (x, y) and (x′, y′) coordinates from multiple interest points. In some examples, a small set of interest points is chosen, and the homograhy is solved for using the RANSAC algorithm (least-squares solution using the SVD algorithm, which is the Jacobi algorithm, in some examples). Next, the homography is applied to the other interest points, and the estimation error is determined. The selection of the subset of interest points is random and is continued until a set number of iterations. In some examples, the number of iterations is set by a user (e.g., user 101). In other examples, it is determined by the type of application utilizing the homography estimation. The final output of this module is the homography of the multiple images.

### Image Transformation and Image Warping (IWP)

The homography matrix may be applied to the image or frame to derive a transformed frame. In some examples an affine transform is used to perform the warping. This module puts the registered or aligned frames onto a frame bus, from where a GPU and/or a CPU will read the frames and perform compositing.

### Architecture for Two-Stage Vector Reduction

In some examples, vector data may be processed in two stages utilizing two-dimensional-processing elements in a systolic array alongside an array of one-dimensional-processing elements. For example, the G-Block 602 may process images utilizing this two stage approach. The processing elements of the array iteratively process data, passing the results of any computations to the nearest neighbors of each processing element. In this example, an image is processed by a kernel, or type of filter, using this hardware architecture, resulting in a more efficient, faster processing of images on a device.

At least some of the modules described herein may utilize or incorporate a two-level vector reduction. In some examples, vector data, such as images, may be processed in two stages utilizing two-dimensional-processing elements in a systolic array alongside an array of one-dimensional-processing elements. The processing elements of the array iteratively process data, passing the results of any computations to the nearest neighbors of each processing element. In this example, an image is processed by a kernel, or type of filter, using this hardware architecture, resulting in a more efficient, faster processing of images on a device.

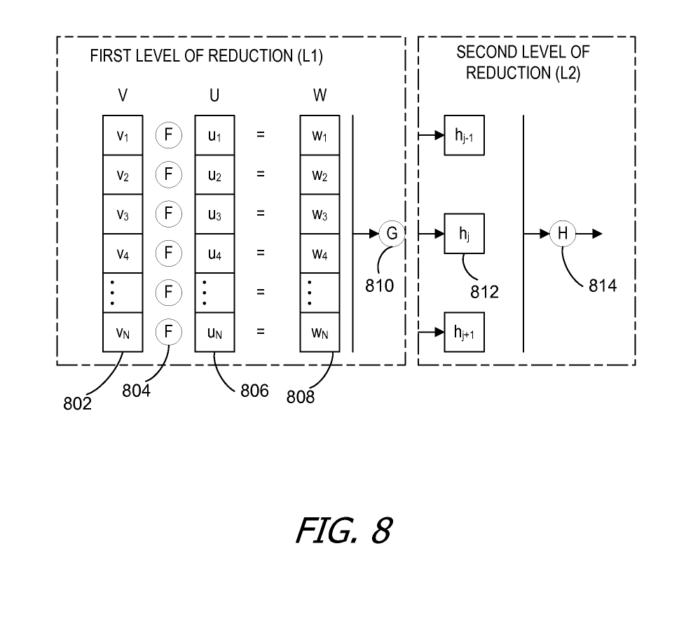

FIG. 8 illustrates the two-stage reduction more generally. In FIG. 8, data set U 806 is associated with an image patch, and data set V 802 is associated with a kernel or filter. Examples of possible filters include Gaussian filters, uniformly distributed filters, median filter, or any other filter known in the art. The data sets U 806 and/or V 802 are stored, for example, in memory area 104. Additionally or alternatively, the data sets U 806 and/or V 802 are received in a transmission from an external source. Additionally or alternatively, the data sets U 806 and/or V 802 are input from an attached device such as a camera or sensor 202.

Utilizing a systolic array enables parallel processing, in two levels of reduction, of the data set U 806. Although the illustrated examples relate to processing images and/or image patches, any data sets may be processed in a systolic array in this manner. In the first level of reduction (e.g., L1), data sets U 806 and V 802 are processed element-wise using a first reduction function F 804. To achieve this, inter-vector data parallelism is utilized, which enables allowing the data set V 802 to be reused across all L1 lanes. The systolic array is utilized to perform the operations and/or to reduce resource costs.

As an example, in a first level of reduction, the first element of data set V 802 is applied to the first element of data set U 806 using function F 804, which yields the first element of data set W 808. In one example, the function F 804 is multiplication and, thus, the vector W 808 is generated by multiplying each element of vector V 802 (for instance, [v₁, v₂, . . . v_{N}]) by the corresponding element of vector U 806 (for instance, [u₁, u₂, . . . u_{N}]). Specifically, in this example, v₁×u₁=w₁, v₂×u₂=w₂, and so on until all elements of data set V 802 have been multiplied by all elements of data set U 806 resulting in a complete data set W 808 ([w₁, w₂, . . . w_{N}]), which has the same number of elements as data sets V 802 and U 806.

In the second level of reduction (e.g., L2), each element wⱼ of the resultant data set W 808 is processed by a second reduction function G 810 to generate an element hⱼ 812. In one example, the function G 810 is an accumulator and/or addition and, thus, the element hⱼ is a scalar product. In this example, the element hⱼ is equal to the sum of w₁+w₂+ . . . +w_{N}. The element hⱼ is generated for each image patch of an image including a plurality of image patches to generate a resultant data set H=[h₁, h₂, hⱼ . . . h_{M}] 814.

When processing overlapping image patches, elements of the data set H 814 and/or and operations associated with generating the elements of the data set H 814 may be interleaved or reused to facilitate decreasing or eliminating the need to recalculate and/or re-fetch data repeatedly from external memory, lowering both memory bandwidth and local storage used.

Various combinations of functions are contemplated for the operations described above. In one example, function F 804 is multiplication and, thus, data set W 808 is the element-wise product of data sets U 806 and V 802. In that example, function G 810 may be addition or accumulation, in which case element hⱼ is the scalar product. In another example of clustering, function F 804 is a distance and, thus, data set W 808 is a distance map of data sets U 806 and V 802 from a centroid. In that example, function G 810 is a comparator, in which case element hⱼ is the nearest neighbor. In another example of image processing, function F 804 is an average and, thus, data set W 808 includes the mean filtered (by data set V 802) pixels of an image patch associated with data set U 806. In that example, function G 810 is a threshold, in which case element hⱼ is an edge location of pixels. In another example of image processing, function F 804 is a gradient and, thus, data set W 808 includes the smoothed filtered (by data set V 802) pixels of an image patch associated with data set U 806. In that example, function G 810 is an addition, in which case element is a dominant optical flow of objects in the image. Although the disclosure is drawn to images, it is understood that the disclosure is not limited to images, but it may also be utilized to process other information such as tags, points in space, generic vectors, etc.

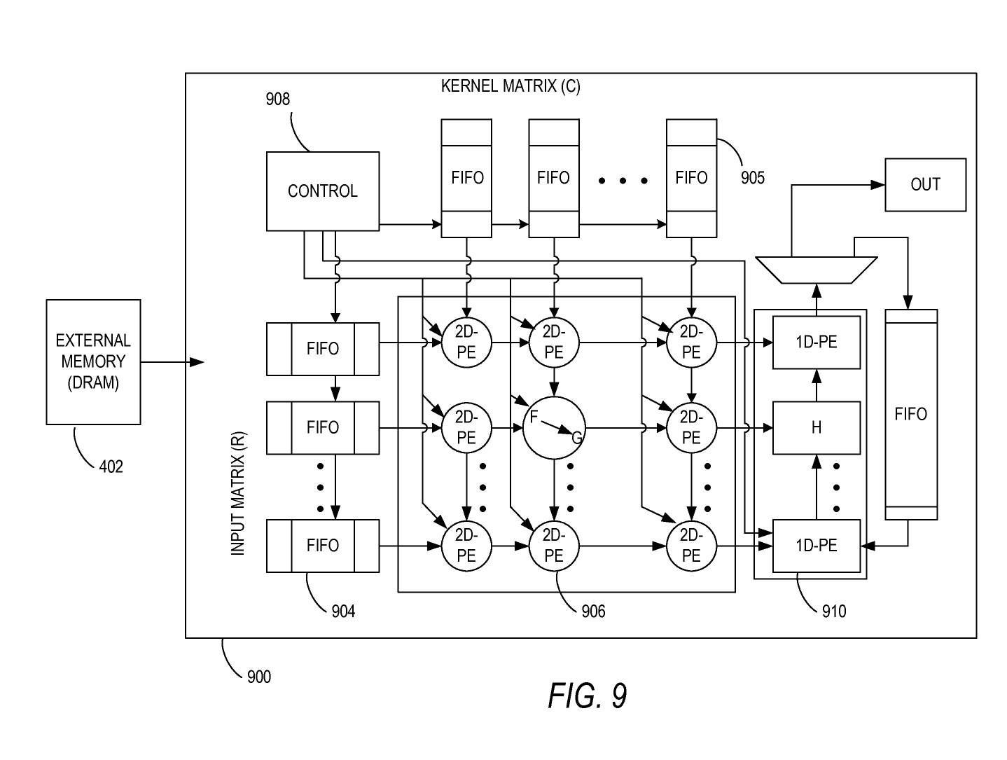

FIG. 9 illustrates a systolic array architecture 900 for implementing the two level vector reduction described above more efficiently. The systolic array architecture 900 allows data to be fed input from an external memory 402 a limited number of times (e.g., once) and reused, which reduces a bandwidth consumed from accessing the external memory 402. The systolic array architecture 900 includes a systolic array of two-dimensional-processing elements (2d-PE) 906, which may include small multiply-accumulate (MAC) units and internal registers for fast-laning (not illustrated). The 2d-PEs 906 are arranged in rows and/or columns, and each element of an input data set (e.g., data set U 806) is associated with a respective row, and each element of a kernel data set (e.g., data set V 802) is associated with a respective column. In this example, there are R number of first-in, first-out (FIFO) rows 904 for the input data set, and there are C number of FIFO columns 905 for the kernel data set.

The disclosed systolic array architecture 900 provides the benefits discussed herein, feeding inputs a limited number of times, reusing data, and/or reducing bandwidth consumed as a result of accessing external memory (e.g., external memory 402). Further, the vector reduction process allows the system to perform two-dimensional convolution along any direction, with varying stride lengths, and kernel sizes.

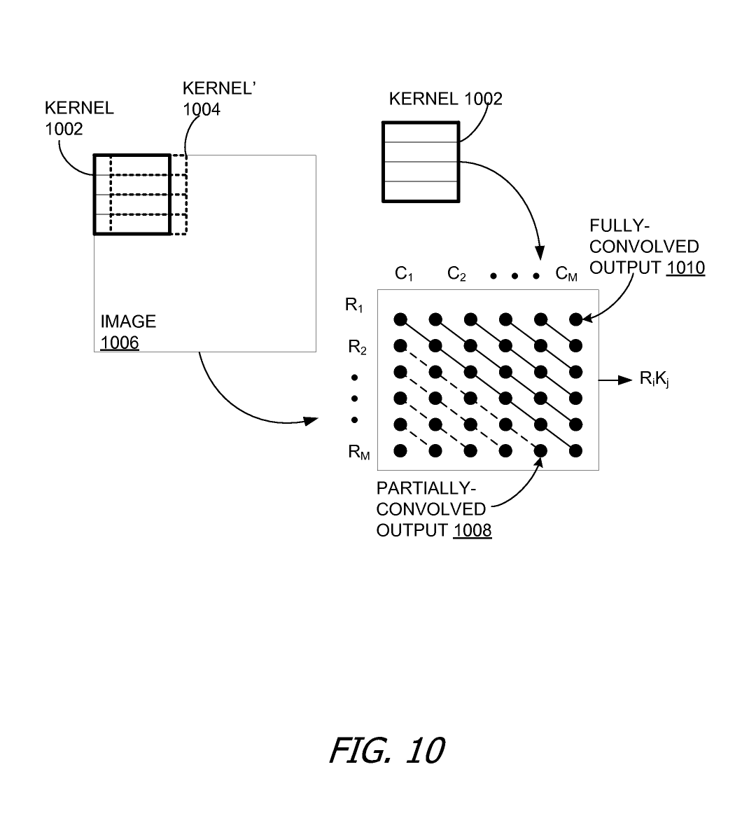

In at least some examples, a control 908 manages an operation and/or a schedule (e.g., clock cycle) of the systolic array architecture 900. On a first clock cycle, element u₁ associated with the first row is transmitted to a 2d-PE 906 positioned on the first row, first column, and element v₁ associated with the first column is transmitted to the 2d-PE 906 positioned on the first row, first column. The F 804 and G 810 functions are implemented at the 2d-PE 906 positioned on the first row, first column (e.g., 2d-PE₁₁) to generate element w₁₁ (e.g., w₁₁=v₁×u₁, and h₁=w₁₁). On each clock cycle, the elements are transmitted to adjacent 2d-PEs 906. For example, on a second clock cycle, one or more relevant elements (e.g., element u₁) are transmitted to an adjacent 2d-PE 906 positioned on the first row, second column (e.g., 2d-PE₁₂), and one or more relevant elements (e.g., element v₁) are transmitted to an adjacent 2d-PE 906 positioned on the second row, first column (e.g., 2d-PE₂₁), where they are processed with an element u₂. For example, at 2d-PE₁₂, element u₁ is processed with element v₂ (e.g., w₁₂=v₂×u₁, and h₁=v₁×u₁+v₂×u₁), and at 2d-PE₂₁, element u₂ is processed with element v₁ (e.g., w₂₁=v₁×u₂, and h₂=w₂₁). After N-clock cycles, 2d-PE_{2(N-1)} generates element h₁ (e.g., h₁=v₁×u₁+v₂×u₁+ . . . v_{N}×u₁), and 2d-PE_{2(N-1)} generates element h₂ (e.g., h₂=v₁×u₂+v₂×u₂+ . . . v_{(N-1)}×u₂), and so on. Accordingly, at any given point in time, the systolic array includes some combination of fully- and partially-convolved outputs. As shown in FIG. 10, an m×m kernel (e.g., Gaussian filter) is iteratively applied to an n×n image to generate a smoothened image.

At least a part of some of the outputs are reused, as at least some elements are re-fed into the engine by passing them from one processing element to its neighbors. In order to accommodate the partially-convolved outputs, a set of one-dimensional processing elements (1d-PEs) 910 is used along the edge of the 2d-PEs 906. The set of 1d-PEs 910 is, in some examples, arranged in a column, as illustrated in FIG. 9. Early in the process, the output of at least some of the 2d-PEs 906 is zero. As the systolic array architecture 900 continues to operate, the systolic array architecture 900 will be more fully convolved at later clock cycles.

The functions performed by the systolic array architecture 900 may be any operation that enables the system to function as described herein. The advantage of passing relevant elements to adjacent or near neighbor 2d-PEs 906 is that the computations are localized and sequential, thereby increasing an opportunity to reuse at least some elements and/or reducing a latency. This system is configurable to any image or kernel size, stride, type, etc.

FIG. 10 illustrates one example of how the system described herein may be utilized. As shown in FIG. 10, a kernel 1002 is “passed over” an image 1006, one patch of pixels at a time. The kernel 1002, which may be associated with a filter, operates on one patch of pixels, then it shifts to the right by some predetermined amount, for instance one column of pixels to the right. The kernel 1002 passes over the entire first row of the image in this manner, shifting over one column of pixels at a time, then it shifts down one row of pixels, and beings again at the left-hand-side of the image 1006.

As shown in FIG. 10, the initial position of the kernel 1002 is illustrated in solid black, and labeled KERNEL 1002. The kernel 1002 is then shifted slightly to the right, and the shifted kernel 1002 is illustrated in a dashed line and labeled KERNEL′ 1004. In some examples, the shift may be more than a column of pixels. The shift size is variable depending on system parameters. This slight shift in processing results in a largely overlapping area as the kernel 1002 shifts to the right. Thus, the systolic array architecture 900 may reuse the output from the first round of computations, and may calculate only the new column of pixels at the edge of the image 1006.

The output is stored in local memory to further reduce the latency of the processing. As shown in FIG. 10, the elements along the diagonal include a desired output that will be available after CM cycles. T patches (of size P×P and centered at locations specified in the IPD output FIFO) are read out from external memory in blocks of pixels. In this example, each iteration includes R inputs, takes (R+CM) cycles, and produces R outputs. Initially, output generated by the systolic array architecture 900 is only partially convolved. As the systolic array architecture 900 progresses through the clock cycles, at least some output becomes fully convolved. Full and partial convolvedness is illustrated by the solid and dashed diagonal lines between elements of the systolic array architecture 900.

Memory consumption associated with the block are RCd×8b for input/output FIFOs of depth d (e.g., 16) and PC×24b to store partially convolved outputs. If pixels are re-fetched from external memory, the hardware consumes an external memory bandwidth of TP2×8b. However, in this example, local buffers are added between the IPD module and the feature-extraction blocks to reduce an opportunity for re-fetching.

### Results

Frame processing times as low as 30 ms may be achieved using the disclosed accelerator. The disclosed accelerator yields an average speed up of 8× over a conventional GPU and 5× over a conventional field programmable gate array (FPGA) at a power level that is lower on average by 14× than the GPU and 3× than the FPGA.

### Example Environment

Example computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an example computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from a user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special-purpose computing device when configured to execute the instructions described herein.

The examples illustrated and described herein as well as examples not specifically described herein but within the scope of aspects of the disclosure constitute an example means for processing an image. For example, the elements described herein constitute at least an example means for generating an image, an example means for transmitting and/or retrieving an image to and/or from a frame bus, an example means for identifying one or more interest points in an image, an example means for extracting one or more features from an interest point, an example means for aligning or registering a plurality of images, and/or an example means for combining a plurality of images to generate a composite image.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The phrase “one or more of the following: A, B, and C” means “at least one of A and/or at least one of B and/or at least one of C.” Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

Alternatively or in addition to the other examples described herein, examples include any combination of the following:
generating a plurality of images;
identifying one or more interest points in the plurality of images;
extracting one or more features from the one or more interest points;
registering the plurality of images to generate a plurality of registered images;
combining the registered plurality of images to generate a composite image;
detecting one or more corners in the plurality of images, wherein each corner of the one or more corners corresponds with a respective interest point of the one or more interest points;
smoothing one or more pixels using a Gaussian filter;
computing one or more gradients along a first axis;
generating an output array including a predetermined number of feature maps;
pooling one or more feature maps along a grid;
registering each image of the plurality of images relative to a common coordinate system;
warping one or more images of the plurality of images using one or more affine transforms;
retrieving a plurality of images from a bus;
transmitting a plurality of images to a bus;
a sensor module configured to generate a plurality of images;
an image sensor processor module configured to process the plurality of images;
an accelerator module configured to register each image of a plurality of processed images;
an accelerator module configured to identify one or more interest points in the plurality of images;
an accelerator module configured to extract one or more features from one or more interest points;
an accelerator module configured to register the plurality of images to generate the plurality of registered images;
an accelerator module configured to register each image of a plurality of images relative to a common coordinate system;
an accelerator module configured to warp one or more images;
a processor module configured to combine a plurality of registered images to generate a composite image;
at least the sensor module and the accelerator module at a mobile device; and
at least the sensor module at a mobile device, and at least the accelerator module at a server coupled to the mobile device.

In some examples, the operations illustrated may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

What is claimed is:

1. A computer-implemented method for processing a multi-frame image, the method comprising executing on a computing device the operations of:
identifying one or more interest points in a plurality of images;
extracting, using the computing device, one or more features from the interest points using one or more of a filter module, a gradient module, a pooler module, and a normalizer module;
based on the extracted features, registering the plurality of images using one or more of a homography estimation module and a warp module to generate a plurality of registered images; and
combining the plurality of registered images to generate a composite image for one or more of high-dynamic range imaging, super high-dynamic range imaging, de-noising, image stabilizing, de-blurring, super-resolution imaging, de-hazing, panoramic stitching, depth of field stacking, and rolling shutter correcting.

2. The computer-implemented method of claim 1, wherein identifying one or more interest points comprises detecting one or more corners, arches, edges, blobs, ridges, textures, colors, differentials, or lighting changes in the plurality of images, wherein a first corner, arch, edge, blob, ridge, texture, color, differential, or lighting change corresponds to a first interest point.

3. The computer-implemented method of claim 1, wherein extracting one or more features comprises smoothing, by the filter module, one or more pixels associated with the interest points.

4. The computer-implemented method of claim 1, wherein extracting one or more features comprises:
computing, by the gradient module, one or more gradients along a first axis and a second axis perpendicular to the first axis; and
based on the computed gradients, generating, by the gradient module, an output array including one or more feature maps.

5. The computer-implemented method of claim 1, wherein extracting one or more features comprises pooling, by the pooler module, one or more feature maps along a grid, wherein the feature maps correspond to the extracted features.

6. The computer-implemented method of claim 1, wherein registering the plurality of images comprises registering the plurality of images with respect to a common coordinate system.

7. The computer-implemented method of claim 1, wherein registering the plurality of images comprises warping one or more images of the plurality of images using one or more affine transforms.

8. The computer-implemented method of claim 1, further comprising:
retrieving the plurality of images from a first bus; and
transmitting the plurality of registered images to a second bus different from the first bus.

9. A mobile device comprising:
a sensor module configured to capture data corresponding to a plurality of images;
a memory area storing computer-executable instructions for processing a multi-frame image based on the plurality of images; and
a processor configured to execute the computer-executable instructions to:
identify one or more interest points in the plurality of images;
extract one or more features from the interest points;
based on the extracted features, register the plurality of images to generate a plurality of registered images; and
combine the plurality of registered images to generate a composite image for one or more of high-dynamic range imaging, super high-dynamic range imaging, de-noising, image stabilizing, de-blurring, super-resolution imaging, de-hazing, panoramic stitching, depth of field stacking, and rolling shutter correcting.

10. The mobile device of claim 9, wherein the processor is configured to execute the computer-executable instructions to detect one or more corners, arches, edges, blobs, ridges, textures, colors, differentials, or lighting changes in the plurality of images, wherein a first corner, arch, edge, blob, ridge, texture, color, differential, or lighting change corresponds to a first interest point.

11. The mobile device of claim 9, wherein the processor is configured to execute the computer-executable instructions to smooth one or more pixels associated with the interest points.

12. The mobile device of claim 9, wherein the processor is configured to execute the computer-executable instructions to:
compute one or more gradients along a first axis and a second axis perpendicular to the first axis; and
based on the one or more computed gradients, generate an output array including one or more feature maps.

13. The mobile device of claim 9, wherein the processor is configured to execute the computer-executable instructions to pool one or more feature maps along a grid, wherein the feature maps correspond to the extracted features.

14. The mobile device of claim 9, wherein the processor is configured to execute the computer-executable instructions to register the plurality of images with respect to a common coordinate system.

15. The mobile device of claim 9, wherein the processor is configured to execute the computer-executable instructions to warp one or more images of the plurality of images.

16. The mobile device of claim 9, further comprising a plurality of busses, wherein the sensor module is configured to transmit the plurality of images to a first bus of the plurality of busses, and the processor is configured to execute the computer-executable instructions to:
retrieve the plurality of images from the first bus;
transmit the plurality of registered images to a second bus of the plurality of busses.

17. A system comprising:
a sensor module configured to capture data corresponding to a plurality of images, and transmit the plurality of images to one or more of a first frame bus and a first network location;
an image sensor processor module configured to retrieve the plurality of images from one or more of the first frame bus and the first network location, process the plurality of images, and transmit the plurality of processed images to one or more of the first frame bus and the first network location;
an accelerator module configured to retrieve the plurality of processed images from one or more of the first frame bus and the first network location, register the plurality of processed images, and transmit the plurality of registered images to one or more of a second frame bus and a second network location; and
a processor module configured to retrieve the plurality of registered images from one or more of the second frame bus and the second network location, and combine the plurality of registered images to generate a composite image for one or more of high-dynamic range imaging, super high-dynamic range imaging, de-noising, image stabilizing, de-blurring, super-resolution imaging, de-hazing, panoramic stitching, depth of field stacking, and rolling shutter correcting.

18. The system of claim 17, wherein the accelerator module is configured to:
identify one or more interest points in the plurality of images;
extract one or more features from the interest points; and
based on the extracted features, register the plurality of images with respect to a common coordinate system to generate the plurality of registered images.

19. The system of claim 17, wherein at least the sensor module and the accelerator module are at a mobile device.

20. The system of claim 17, wherein at least the sensor module is at a mobile device, and at least the accelerator module is at a server coupled to the mobile device.
